(19) United States
(12) Patent Application Publication
(10) Pub. No.: US 2008/0290073 A1
(43) Pub. Date: Nov. 27, 2008

(54) Single Weld Head

(75) Inventor: Charles Wood, Eden Prairie, MN (US)

Correspondence Address: VIDAS, ARRETT & STEINKRAUS, P.A., SUITE 400, 6640 SHADY OAK ROAD, EDEN PRAIRIE, MN, 55344, US

(73) Assignee: TechMatrix, LLC, Eden Prairie, MN (US)

(21) Appl. No.: 12/032,853

(22) Filed: Feb. 18, 2008

Related U.S. Application Data
(60) Provisional application No. 60/890,563, filed on Feb. 19, 2007.

(51) Int. Cl. B23K 11/00

(52) U.S. Cl. 219/117.1; 219/78.01

(57) ABSTRACT

A welding apparatus includes a single weld head, a weld power supply, a conductive fixture plate, a data acquisition card, and a computer. The single weld head includes one or more electrodes, one or more actuating devices in operative communication with the electrodes, and one or more force control devices in operative communication with the actuating devices. The weld head is in communication with a weld power supply. The weld power supply welds articles in accordance with a computer program running on a computer. The computer is in communication with the weld power supply, the force control device, and the data acquisition card. The computer is capable of receiving, evaluating, and storing welding data received from the data acquisition card. The apparatus further includes a switch in communication with the weld power supply, the electrodes, the conductive fixture plate, and the data acquisition card.

### CROSS-REFERENCE TO RELATED APPLICATIONS

This application claims priority to a provisional application, Ser. No. 60/890,563, filed Feb. 19, 2007, the disclosure of which is expressly incorporated herein by reference in its entirety.

### STATEMENT REGARDING FEDERALLY SPONSORED RESEARCH

Not Applicable

### BACKGROUND OF THE INVENTION

1. Field of the Invention

This invention relates generally to welding and in particular to a welding apparatus that uses a single weld head, and a welding method which uses the welding apparatus.

2. Description of the Related Art

The invention relates to being able to easily switch between opposed, series and step resistance welding methods. Welding small parts often involves using a combination of these welding methods on a single part. Also, low product mix manufacturing environments may involve welding some parts with opposed electrodes and other parts with series or step electrodes.

As compared with conventional small scale resistance weld heads, the welding apparatus of the present invention has several advantages. The first advantage of the present invention is the ability to change between resistance weld methods without having to dedicate weld heads, controllers, and fixtures to each resistance weld method. This reduces manufacturing change-over time and greatly increases production throughput. Other benefits of using fewer weld heads and controllers is the reduced capital expense, reduced floor (i.e. table) space, and the number of operators needed to operate these systems.

A second advantage of the present invention is a reduction in the maintenance expense associated with having multiple weld heads, controllers, and fixtures. Normally, one would have to purchase, maintain and calibrate a weld head and controller for both a dedicated opposed electrode welding apparatus and a dedicated series welding apparatus. It is well known that because resistance welding requires intimate contact with the parts being welded, the electrode tips will periodically have to be redressed. A manufacturing operation containing multiple weld heads requires redressing more electrodes, thereby resulting in lost productivity because the electrodes are often removed for service. The weld head and power source must also be periodically calibrated to ensure the electrode force and power output meet manufacturer specifications.

A third advantage of the present invention is being able to automatically adjust the electrode force depending on the parts being welded. Electrode force is a critical process parameter that has a great effect on resistance weld nugget formation. This in turn affects weld strength and consistency. The part's geometry, material, and mass dictates the amount of electrode force, weld energy, weld time, and electrode tip configuration that will result in a robust process and will often vary from one part design to the next. It is beneficial to have the flexibility to change the electrode force without requiring production personnel to make manual adjustments to the weld head. The single weld head apparatus and computer ensure that the electrode force is correct for each part. The weld head also prevents the operator from changing the electrode force because the adjustment must be done through the use of the computer interface which contains security provisions to prevent unauthorized parameter adjustment.

A fourth advantage of the present invention lies in automating the resistance weld process. It is much simpler to move and control a single weld head using a single robot than it is to move multiple weld heads within a work envelope using multiple robots. There are less axes of motion required for the single weld head, hence fewer motors, stages, and motor amplifiers are needed to position the head to various locations.

A fifth advantage of the present invention is the incorporation of a digital camera, zoom lens, and lighting. Previously, some weld heads incorporated a microscope to allow the operator to view and hold the parts in the correct location during welding, but this technique has undesirable ergonomics and leads to operator fatigue. Another common approach is to use a digital camera and lens, but display the image on a separate video monitor. This can add significant cost to the system and does not allow images or movies to be digitally saved. The single weld head invention is integrated with a custom computer program to work with the vision system on the weld head. Now, digital images of the parts can be taken before, during, and after the weld cycle completes and stored on a hard drive. Also, because the images are displayed on the computer monitor and incorporated directly into the software application, an operator or vision program can qualitatively or quantitatively evaluate the spot weld's quality and document the weld results. In addition, the camera and software make it easy to train the system to locate small part features and preprogram (i.e. train) the desired spot weld locations.

The art referred to and/or described above is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All U.S. patents and applications and all other published documents mentioned anywhere in this application are incorporated herein by reference in their entirety.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. § 1.72.

### BRIEF SUMMARY OF THE INVENTION

An apparatus and method to perform opposed, series and step resistance welding is disclosed. The apparatus allows a user to perform any combination of these welds using a single weld head. The weld head is controlled by a computer and software that positions the single head into various weld positions, then performs a resistance weld. Alternatively, the weld head may be used without stages and motion control hardware, such that an operator moves the part into position and then activates a switch to perform a weld.

The weld head combines what has traditionally been done with dedicated weld heads and controllers into a single system. Depending on the part program, the weld head will extend a plurality of electrodes against the part, use a feedback loop to measure the electrode force, then “fire” the controller to begin the appropriate weld schedule. The electrodes are extended using a precision actuator to ensure an accurate force and quick response time (i.e. follow-up) is achieved during the weld process. Depending on the type of weld, the anode and cathode power supply wires are electronically switched to conduct the current from an electrode through the parts being welded and onto the fixture plate or alternatively, through the parts being welded and back up through a second electrode.

In at least one embodiment, the invention is directed to a resistance welding apparatus capable of performing opposed, series, and step resistance welding with a single weld head with at most two electrodes. The apparatus includes a single weld head, a weld power supply, a conductive fixture plate, a data acquisition card, and a computer. One skilled in the art will understand that modern power supplies often integrate a controller, thus in at least one embodiment of the present invention, the weld power supply is understood to include a controller. Also, the term “computer” is used herein to refer to any electronic device that stores instructions and is able to process, store, and retrieve data according to those instructions. As such, the term “computer” as used herein is synonymous with the terms “controller” and “micro-controller.”

The single weld head includes at least one electrode, at least one actuating device in operative communication with the at least one electrode, and at least one force control device in operative communication with at least one actuating device. The weld head is in communication with a weld power supply. The weld power supply welds articles in accordance with a special program running on a computer. The phrase “in communication” is understood to mean at least electrical communication, optical communication, and wireless communication (such as through RF signals).

The computer is in communication with the weld power supply, the force control device, and the data acquisition card. The computer is capable of receiving, evaluating, and storing welding data received from the data acquisition card and weld power supply.

The apparatus further includes a high current switch in communication with the weld power supply, at least one electrode, the conductive fixture plate, the data acquisition card, and the computer.

In some embodiment of the present invention, the weld held includes a means to control the force that the electrode exerts on the materials being joined.

The phrase “in communication” as used herein is understood to mean at least electrical communication, optical communication, and wireless communication (such as through RF signals).

Some embodiments of the present invention are directed towards methods of using the welding apparatus. In at least one embodiment, the apparatus is used in a method of series resistance welding or step resistance welding (i.e. parallel gap). The method includes: generating a first signal via the program running on the computer; outputting the first signal from the computer to the data acquisition card; outputting a second signal from the data acquisition card to the switch in response to the first signal; and actuating the switch, thereby establishing electrical communication between the second electrode and the negative terminal of the weld power supply, and thereby preventing electrical communication between the weld power supply and the conductive fixture plate.

In some embodiments, the apparatus is used in a method of direct (i.e. opposed electrode) resistance welding. The method includes: generating a first signal via the program running on the computer; outputting the first signal from the computer to the data acquisition card; outputting a second signal from the data acquisition card to the switch in response to the first signal; and actuating the switch, thereby establishing electrical communication between the conductive fixture plate and the negative terminal of the weld power supply, and thereby preventing electrical communication between the weld power supply and the second electrode.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawings.

FIG. 1 is a simplified control block diagram of an exemplary implementation of an electrode actuator, force feedback, and controller, in accordance with at least one embodiment of the present invention.

FIG. 2 is a schematic diagram of an exemplary implementation of a single weld head, in accordance with at least one embodiment of the present invention.

FIGS. 3A-3E depict a schematic overview of an exemplary implementation of the welding apparatus, in accordance with at least one embodiment of the present invention.

FIG. 4 is a flow chart of an exemplary implementation of a method of using a single weld head, in accordance with at least one embodiment of the present invention.

FIG. 5 is a flow chart of an exemplary implementation of another method of using a single weld head, in accordance with at least one embodiment of the present invention.

FIG. 6 is a perspective view of an exemplary implementation of a single weld head within a semi-automated welding apparatus, in accordance with at least one embodiment of the present invention.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

As stated above, the present invention is directed towards a welding apparatus and method that allows a user to perform opposed, step, and series resistance welding using a single weld head.

Generally speaking, opposed welding, also known as direct welding, occurs when electrodes are placed on opposing sides of the article to be welded, or as in the instant application, between an electrode and a conductive plate acting as an electrode. Welding current flows from one electrode through the articles to be welded together, and to the other electrode/conductive plate.

Step welding, also known as indirect welding, is used when access to the articles to be welded is limited, such as access to only one side. For example, in one simple configuration, rather than being opposed to one another, the electrodes may be oriented in the same direction. One electrode is placed over the two articles to be welded together while a second electrode is placed over only one of the articles (creating a “step”). Welding current flows from one electrode, through one of the articles to be welded together, through the area of the weld, and into the other electrode. Step welding results in a single weld nugget.

Finally, series welding, also known as parallel gap welding, is also used when access to the articles to be welded is limited, such as access to only one side. For example, in one simple configuration, rather than being opposed to one another, the electrodes may be oriented in the same direction, like in step welding. In such a configuration, both the first and second electrodes are placed over the two articles to be welded together. Series welding produces two weld nuggets. It should be noted that there are numerous other configurations of opposed, step, and series welding not described above that one of ordinary skill in the art would recognize.

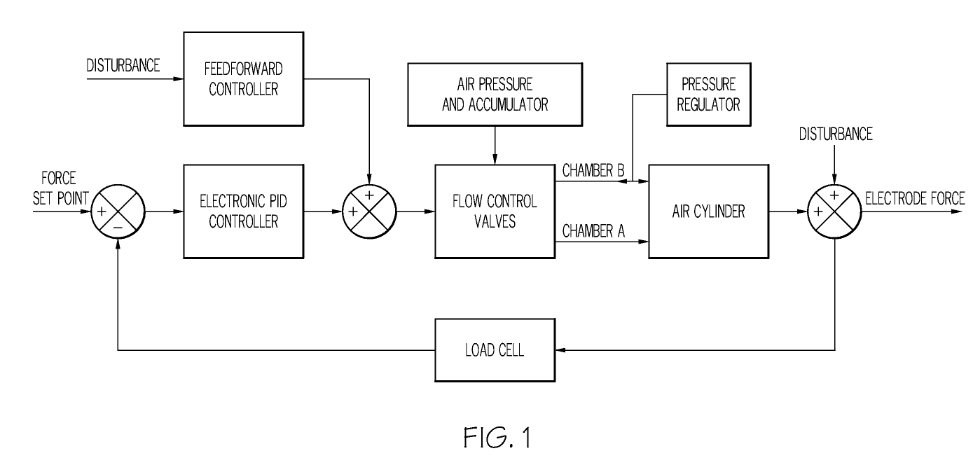

It should be noted that the present invention allows the air cylinder to be configured without any flow control valves. Flow control valves are normally used to control the velocity of an air cylinder piston, but if employed here, would only increase viscous friction and thereby retard the responsiveness of the system. Also, in the preferred embodiment, the air lines between the electro-pneumatic valve and air cylinder have a large inside diameter and their length is very short. This minimizes the pressure drop and the time delay between the valve and cylinder, which improves the system's transient response. In some embodiments, both the cylinder velocity and its force are controlled by the command signal sent to the electro-pneumatic regulator. A simplified control block diagram of the electrode actuator, force feedback and controller is shown in FIG. 1.

One skilled in the art of mechanical design will recognize that the electrode system dynamics can be described using Newton's second law and frictional forces. The equation below describes the force required to move the load:

Fₑ=m\ddot{x}+F_{f},

where Fₑ is the total force required to move the electrode load, m is the mass of the electrode, electrode holder, piston rod, stage carriage, and any other components that move when the air cylinder actuates, and F_{f} is the total frictional force, which includes static, dynamic, viscous, and rolling friction. Each component within the assembly may include one or more of these friction forces. The design goal is to minimize the system mass and friction forces. Therefore, lightweight materials such as aluminum and plastic are employed to minimize mass, while ultra low friction elements like air bearings are used to drive the load. The purpose of the pressure regulator fed into Chamber B is to act as a counter force to the weight of the load, because the mass is always greater than zero. One skilled in the art will know that this counter force could have been provided by a counter weight, constant force spring or other means to balance the load. For a rigorous analysis of the piston, valve, and air line system dynamics, please see “A High Performance Pneumatic Force Actuator System Part 1—Nonlinear Mathematical Model”, by Edmund Richer and Yildirim Hurmuzlu, Southern Methodist University, School of Engineering and Applied Sciences, Mechanical Engineering Department, Feb. 12, 2001, the entire contents of which is hereby expressly incorporated by reference.

In at least one embodiment, a low friction air cylinder is used in combination with a load cell and electro-pneumatic regulator. The load cell provides a force feedback signal to the electro-pneumatic regulator that contains a proportional-integral-derivative (i.e. PID) controller to close the force loop. The term “PID controller” is understood to include a wide variety of feedback systems including, but not limited to, Feedforward PID, Cascading PID, and fuzzy logic controllers. These types of controllers and their variations could all be employed to control the actuating device and electrode force. The desired electrode force setting is provided by the computer and sent to the electro-pneumatic regulator as the command signal. At this point the electro-pneumatic regulator adjusts the output pressure in chamber A and chamber B of the air cylinder such that the feedback force signal is equal to the output signal. In other words, the PID loop minimizes the amplified force error signal.

Also, in at least one embodiment, a feedforward controller is used in addition to the PID feedback. The feedforward controller anticipates the disturbance of the force change that occurs when the weld nugget suddenly forms and the electrode attempts to maintain contact with the articles being joined (i.e. follow-up). The feedforward controller calculates additional gain based on information about the weld schedule timing and electrode set point force and sends a signal to the proportional valve. This is an important feature that overcomes the dead band and dead time characteristics associated with pneumatic actuators.

In some embodiments, the design of the electro-pneumatic regulator is critical with respect to the air cylinder. The air cylinder contains air bearings which are design to leak at a defined flow rate and provide a laminar cushion of air around the air cylinder pistons - minimizing static and dynamic friction. The leakage rate is designed into the electro-pneumatic regulator by specifying a proportional valve and orifice plate with approximately the same leakage as the air cylinder. This technique effectively cancels the effect of air leakage on the control loop and makes it much easier to control.

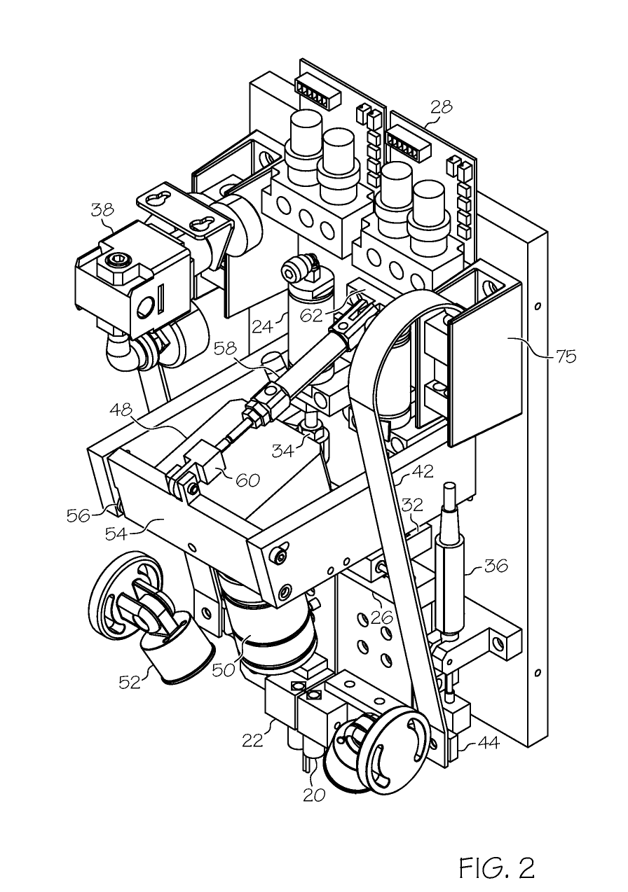

Referring now to FIG. 2, an exemplary single weld head of the welding apparatus is depicted in accordance with at least one embodiment of the present invention. FIG. 2 shows the components inside the weld head, shown generally at 10, with its cover removed. In at least one embodiment, there are one or more electrodes 20 attached to electrode holders 22. Each electrode/electrode holder pair is equipped with an actuating device 24 to apply force to the parts being welded. The actuating device 24 may be an air cylinder, a linear actuator or a preloaded spring.

A computer or weld power supply (not depicted) sends command signals to the force control device 28 to adjust the electrode forces required per the weld schedule. Each electrode is mounted to a linear cross-roller stage 26. In at least one embodiment, the force control device is an electro-pneumatic regulator. Attached to the stage 26 are a load cell 32 and a floating joint 34 that compensate for slight misalignment to the actuating device. Next to each stage is a high accuracy displacement sensor 36 used to precisely measure electrode displacement and follow-up dynamics throughout the weld. The low voltage weld signal, used for feedback purposes, is measured by attaching a wire lead to the anode electrode and another to the cathode electrode (not shown).

Still referring to FIG. 2, a counter force to balance the weight of the electrode, electrode holder, and stage is provided by a precision air regulator 38. This method “zeros” the weight of the assembly and provides accurate force PID control. A first signal from the load cell is sent back to the force control device to close the force loop while a second load cell signal is sent back to the computer data acquisition card (DAQ)(not shown) to record measurement force throughout the weld cycle. The displacement sensor, force output signal from the load cell, and weld electrical characteristics are all measured by the DAQ and stored on the computer. Special computer software uses these signals to ensure the weld process is consistent and within predefined limits.

A high amperage weld cable (not shown) is secured to a terminal block 75 from the electrodes. Attached to the terminal block 75 is a thin and flexible, jumper cable 42 which is connected to a twisted bus bar 44. The bus bar 44 is secured to an electrically insulated electrode stage 26. The jumper cable is looped to minimize downward forces on the electrode stage 26, thereby making electrode force control more consistent.

A shielding gas tube (not shown) blows gas, such as argon, across the electrodes and parts being joined to minimize part discoloration. The shielding gas also minimizes part brittleness and cracking by controlling weld nugget microstructure.

Referring still to FIG. 2, some embodiments of the present invention include a camera 48, an adjustable zoom lens 50 focused on the electrodes, and computer controlled LED lights 52. In at least one embodiment, the camera is a digital camera. In some embodiments the digital images are stored on the computer. In at least one embodiment, the camera may be an analog camera in communication with software that allows the image to be digitized and stored on the computer. The camera, zoom lens, and LED lights provide live or snapshot images of the welding process. As shown in FIG. 2, a single camera 48 is mounted on the camera mount plate 54. The plate 54 is mounted to bearings 56 that allow the camera to pivot from a slight angle to vertical using an air cylinder 58. The actuating device is connected to the camera mount plate using a knuckle 60 on the piston end. And, the actuating device is connected to the single weld head plate using a clevis 62. The camera tilt is controlled by the computer electronics. The single weld head and camera is used to accurately measure part geometry and part-to-part geometry before or after the parts have been joined. The camera is also used to make qualitative assessments of the spot weld to predict joint strength. Furthermore, the camera may be tilted to simplify electrode-to-part positioning during setup. Validating weld quality using the camera and the process signals along with the computer software ensures the joined parts meet specifications.

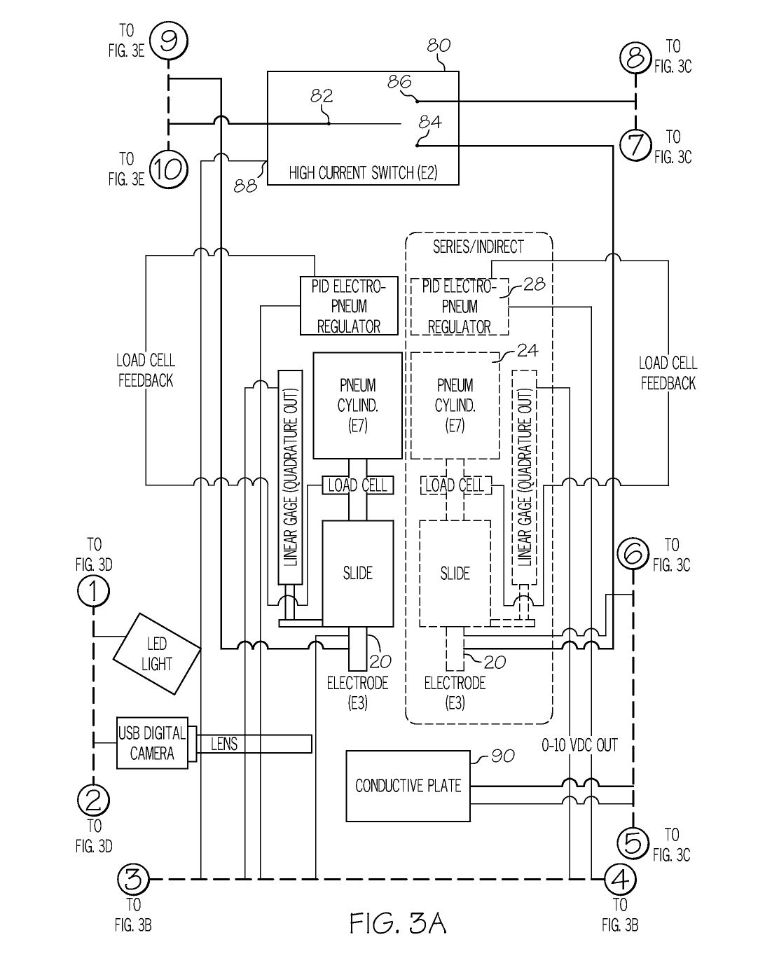

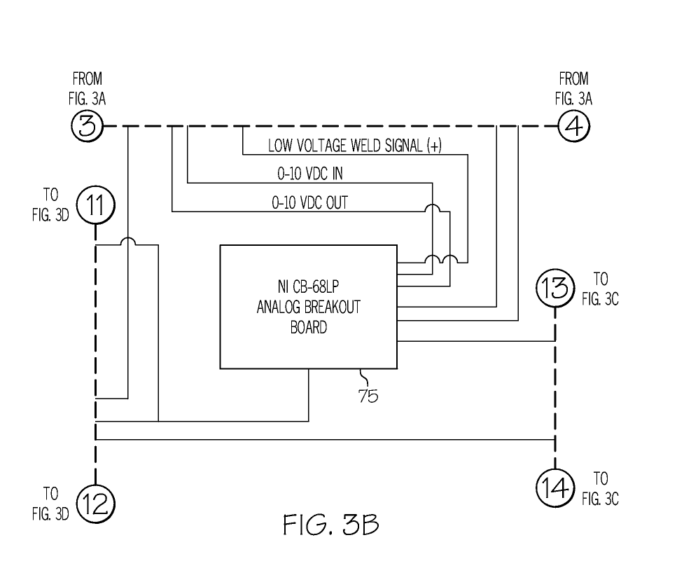

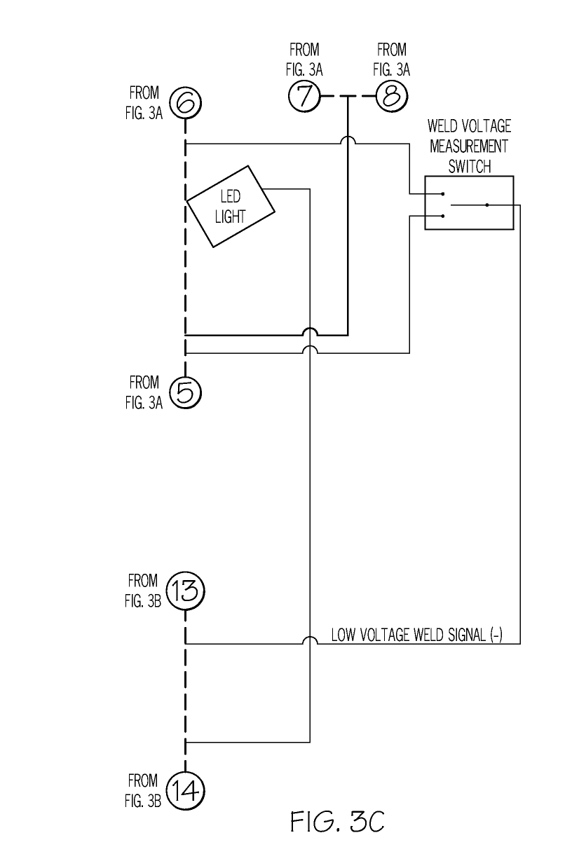

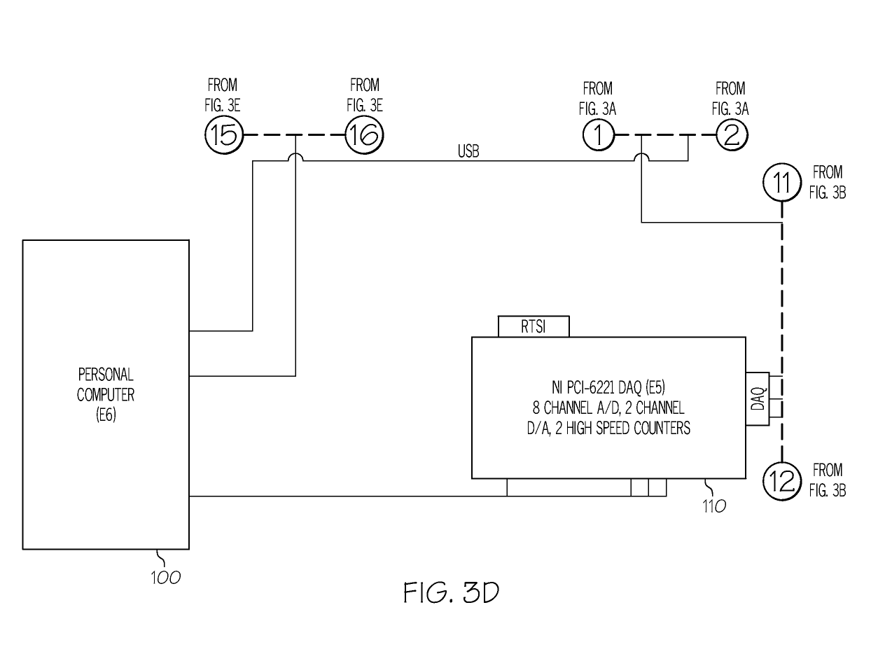

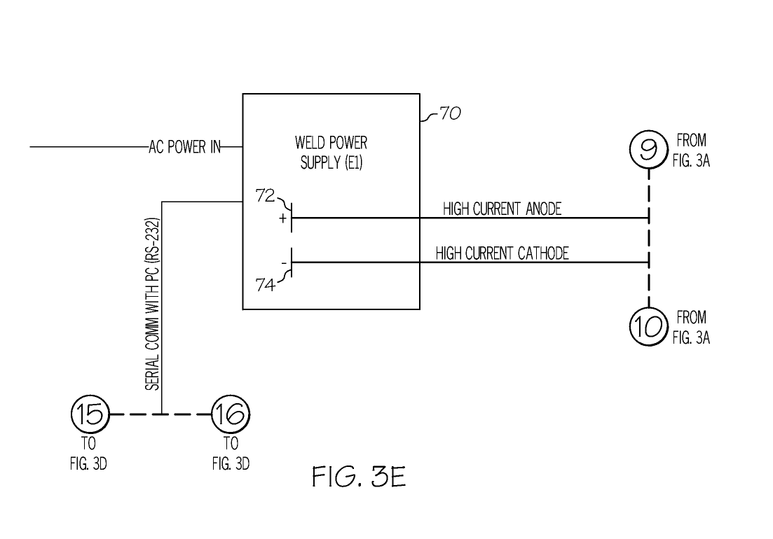

Referring now to FIGS. 3A-3E, an exemplary overview of the welding apparatus is depicted in accordance with at least one embodiment of the present invention. FIGS. 3A-3E shows a single weld head 10 with one or more electrodes 20, each electrode being engaged to an electrode holder (not depicted). The single weld head further includes one or more actuating devices 24, and one or more force control devices 28. As seen in FIGS. 3A-3E, the electrodes are in operative communication with the actuating devices. Furthermore, the actuating devices are in operative communication with the force control devices 28.

Still referring to FIGS. 3A-3E, the weld head 10 is in communication with the weld power supply 70. A positive terminal 72 of the weld power supply is engaged to one of the electrodes 20, while a negative terminal 74 of the weld power supply is engaged to a high current switch 80. Specifically, the negative terminal 74 of the weld power supply is engaged to the common terminal 82 of the switch 80. In at least one embodiment, the switch 80 is a high-current relay. In some embodiments, the switch 80 is an electromechanical relay while in other embodiments the switch 80 is a solid state relay. One of ordinary skill will recognize that there are numerous other devices and/or configurations which could be substituted for relay 80 without deviating from the spirit of the invention, such as a silicon controlled rectifier (SCR) or mechanical contactor as the switch. One of the terminals 84 of the switch is engaged to one of the electrodes. The other terminal 86 of the switch is engaged to a conductive fixture plate 90, whose use will be described in more detail below. The switch is controlled by control signals sent by the computer 100 via the data acquisition card (DAQ) 110 to pin 88 of the switch.

As seen in FIGS. 3A-3E, the computer 100 is in communication with the DAQ 110. In some embodiments, the DAQ may be a National Instruments model number NI PCI-6221 card. The DAQ is used to acquire data for storage and evaluation by software running on the computer. The DAQ is also used by the computer to output analog and digital control signals to components, such as the switch and force control device. Also, FIGS. 3A-3E show the DAQ 110 in communication with the force control devices via the terminal block 75.

The computer 100 communicates with the weld power supply 70 and the DAQ to switch between direct, indirect, and series resistance welding. Specifically, an operator uses the special software running on the computer 100 to select the appropriate part number of the part to be welded. Stored on the computer is a predefined weld schedule for each part number. The operator initiates a weld cycle, the software selects the predefined weld schedule associated with the part number, and the appropriate weld schedule is executed by the weld power supply. The weld schedule includes whether the part will be opposed, series, or step welded. The software ensures that the electrode force is correct for each part. And, the software prevents the operator from changing the electrode force; any adjustment to the electrode force must be done through the use of a computer interface that contains security provisions to prevent unauthorized parameter adjustment.

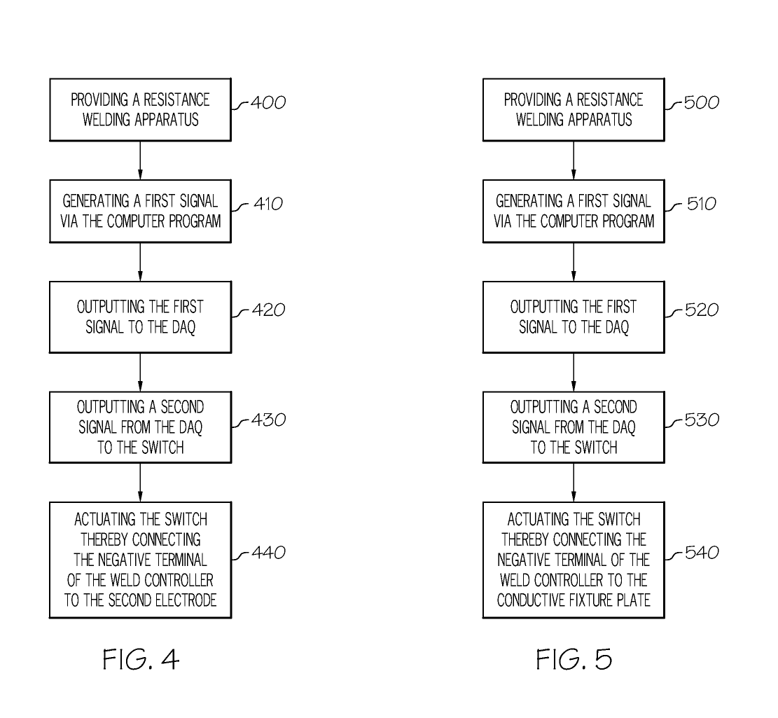

At least one embodiment of the present invention is directed towards a method of series welding or step welding using the above-described welding apparatus, as depicted in FIG. 4. Using the above-described welding apparatus (shown at 400), the computer, via the special software program, generates a signal based on the weld schedule of the part to be welded (shown at 410) and outputs the signal to the DAQ (shown at 420). The DAQ then sends a signal to actuate the high current switch (shown at 430) located on the secondary side of the weld power supply to ensure that the right-hand electrode within the weld head becomes the negative lead (shown at 440) and the conductive fixture plate 90 is disconnected from the weld circuit. The signal also actuates a relay to alter the connection of the low voltage weld signal. The low voltage weld signal is separate from the high current power lines, but like the high current lines, the low voltage weld signal must be switched depending on the connection of the cathode.

Some embodiments of the present invention are directed towards a method of opposed welding using the above-described welding apparatus, as depicted in FIG. 5. Using the above-described welding apparatus (shown at 500), the computer, via the special software program, generates a signal based on the weld schedule of the part to be welded (shown at 510) and outputs the signal to the DAQ (shown at 520). Parts are welded in an opposed electrode fashion when only one of the electrodes within the single weld head is connected to the secondary side of the weld power supply and the other electrode is effectively disconnected from the weld circuit. The DAQ sends a signal to the force control device, signaling the air cylinder to retract the unused electrode for opposed electrode welding. The DAQ then sends a signal to actuate the switch (shown at 530) to connect the conductive fixture plates 90 to become part of the resistance weld circuit. These plates then act as the negative lead (i.e. the opposed electrode), thereby completing the weld circuit.

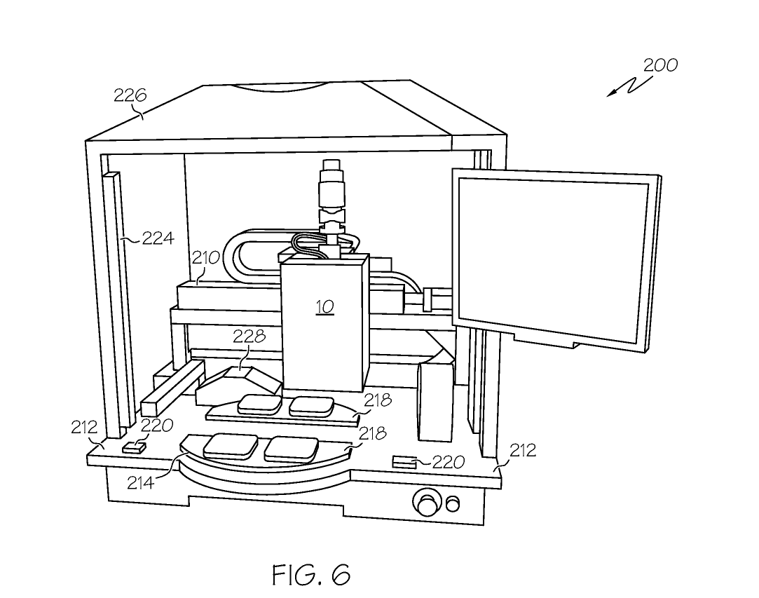

Referring now to FIG. 6, an exemplary semi-automated resistance spot weld system is depicted in accordance with at least one embodiment of the present invention. The semi-automated resistance spot weld system, shown generally at 200, includes a Cartesian gantry robot 210 mounted on a base plate 212. A rotary table 214 is also mounted on the base plate 212. An operator loads the parts to be welded on the fixture plate 218 and then uses the system's computer to select the appropriate part number within the software program. The operator presses the palm buttons 220 on either side of the rotary table to initiate a cycle. The machine software selects the predefined weld schedule and loads it into the weld controller (not shown). Next, the rotary table 214 rotates to the appropriate angle, placing the recently loaded parts within the work envelope of the gantry robot 210. The operator is now able to safely load the other side of the fixture plate 218 with parts while the computer instructs the gantry robot 210 to move the weld head 10 to various positions behind the light curtain 224. The metal and plastic cover 226 protects the operator from the moving weld head 10 on the top, sides, and rear of the machine. After a predefined number of weld cycles, the computer software will automatically redress the electrodes within the weld head 10 by moving the head with the gantry robot 210 over to the redressing station 228. Redressing the electrode tips provides high quality and more consistent resistance welds.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A resistance welding apparatus capable of performing opposed, series, and step resistance welding with a single weld head, the apparatus comprising:
a single weld head, the single weld head comprising:
at least one electrode;
at least one actuating device, the at least one actuating device in operative communication with the at least one electrode;
at least one force control device, the force control device in operative communication with the at least one actuating device;
a weld power supply for welding articles in accordance with a computer program, the weld power supply being in electrical communication with the single weld head;
a conductive fixture plate;
a data acquisition card;
a computer, the computer running the program, wherein
the computer is capable of receiving, evaluating, and storing welding data, and wherein
the computer is in communication with the weld controller and the data acquisition card, and wherein
the computer is in communication with the regulator; and
a switch, the switch being in communication with the weld power supply, the at least one electrode, the conductive fixture plate, and the data acquisition card.

2. The welding apparatus of claim 1, wherein the single weld head further comprises at least one camera, the at least one camera being in communication with the computer.

3. The welding apparatus of claim 2, wherein the at least one camera comprises a zoom lens.

4. The welding apparatus of claim 2, further comprising lights, the lights being in communication with the computer.

5. The welding apparatus of claim 4, wherein the at least one camera captures at least one image, the at least one image being digitized and stored on the computer.

6. The welding apparatus of claim 1, further comprising a robot, the robot being in communication with the computer, the robot being in further communication with the single weld head.

7. The welding apparatus of claim 1, wherein the single weld head further comprises at least one displacement sensor.

8. The welding apparatus of claim 1, wherein the single weld head further comprises at least one load cell.

9. The welding apparatus of claim 1, wherein the at least one actuating device is an air cylinder.

10. The welding apparatus of claim 1, the single weld head further comprising:
at least one electrode holder, the at least one electrode holder engaged to the at least one electrode, the at least one electrode holder and the at least one electrode in combination forming at least one electrode assembly; and
at least one counter balance device, the at least one counter balance device constructed and arranged to offset the weight of the at least one electrode assembly.

11. The welding apparatus of claim 10, further comprising at least one PID feedback system, the at least one feedback system tuned and adjusted to precisely control the electrode force and electrode force disturbances.

12. The welding apparatus of claim 1, wherein the single weld head comprises a first electrode and a second electrode, and wherein the first electrode is in electrical communication with a positive terminal of the weld power supply, and wherein the switch is in electrical communication with a negative terminal of the weld power supply, and wherein the first electrode is in operative communication with a first actuating device, and wherein the second electrode is in operative communication with a second actuating device.

13. The welding apparatus of claim 1, wherein the computer is in electrical communication with the weld controller and the data acquisition card.

14. The welding apparatus of claim 1, wherein the computer is in wireless communication with the weld controller and the data acquisition card

15. A method of series resistance welding, the method comprising:
providing the resistance welding apparatus of claim 12;
generating a first signal via the program running on the computer;
outputting the first signal from the computer to the data acquisition card;
outputting a second signal from the data acquisition card to the switch in response to the first signal; and
actuating the switch, thereby establishing electrical communication between the second electrode and the negative terminal of the weld power supply, and thereby preventing electrical communication between the weld power supply and the conductive fixture plate.

16. A method of opposed resistance welding, the method comprising:
providing the resistance welding apparatus of claim 12;
generating a first signal via the program running on the computer;
outputting the first signal from the computer to the data acquisition card;
outputting a second signal from the data acquisition card to the switch in response to the first signal; and
actuating the switch, thereby establishing electrical communication between the conductive fixture plate and the negative terminal of the weld power supply, and thereby preventing electrical communication between the weld power supply and the second electrode.

17. The method of claim 16, further comprising:
generating a third signal via the program on the computer;
outputting the third signal from the computer to the data acquisition card;
retracting the second actuating device via a second force control device in response to the third signal, the second force control device being in operative communication with the second actuating device.
